(19) United States
(12) Patent Application Publication
(10) Pub. No.: US 2025/0220025 A1
(43) Pub. Date: Jul. 3, 2025

(54) COMPUTER-IMPLEMENTED METHOD FOR GATHERING USABLE INFORMATION FROM AN UNRELIABLE DATA SOURCE AND RELATED SYSTEM

(71) Applicant: Klaviyo, Inc., Boston, MA (US)

(72) Inventors: Andrew Shearer, Barrington, RI (US); Charlie Steele, Boston, MA (US); Dmitry Mamyrin, Boston, MA (US); Collin Crowell, Austin, TX (US)

(21) Appl. No.: 18/974,657

(22) Filed: Dec. 9, 2024

Related U.S. Application Data
(60) Provisional application No. 63/616,592, filed on Dec. 30, 2023.

(51) Int. Cl. H04L 9/40; H04L 67/14

(52) U.S. Cl. CPC H04L 63/123; H04L 67/14

(57) ABSTRACT

Described herein is a computer-implemented method for gathering data from a remote unreliable data source. A method comprises: sensing the remote server for operation; dividing, if the remote server is operational, the requested data range into a current data range and a deferred data range; recursively or iteratively interrogating the current data range to identify toxic records and save valid records; updating the current data range to the deferred data range from the dividing step; and repeating the steps until no deferred data ranges are available to request. Optionally, a sync module is programmed and operable to accept data range identifiers from a user to configure the data request. Related systems are also described.

### TECHNICAL FIELD

This generally relates to computer data processing, and more particularly, computer-systems for gathering usable information from an unreliable data source.

### BACKGROUND

Fetching data from a remote server can be thwarted by the presence of a single toxic record. A toxic record is a datum that causes any requests that attempt to return or process the toxic record to fail. It is not unusual to encounter such records when requesting data from a cloud-based data source such as a remote application programming interface (API). Data requests can fail for a variety of reasons such as, for example, invalid data, an invalid data format, or bugs in the remote system code that cause the entire request to fail.

These types of failed requests tend to result in non-specific error messages being returned to the requesting system (such as, e.g., a 500 Internal Server Error when using HTTP). The messages tend not to identify the specific problem, which record caused it, or even whether the entire system is down or just this one record. This is a difficult problem for data retrieval because of the uncertainty as to the cause.

Approaches to dealing with the above-described problem include ignoring the failed requests, record-by-record requests, and to retry the request.

Ignoring the failed request loses data for transient errors (such as temporary network outages), and loses neighboring data when requests span many records.

Record-by-record requests also have shortcomings. If each request covers the smallest possible quantum of data (such as a single record) rather than gathering it in larger batches, errors will not cause neighboring data to be lost, but the computational overhead is extremely high. This strategy can reduce efficiency by orders of magnitude. Unless retries are added to this system, transient errors unrelated to toxic records can also cause data to be lost.

Retries are also not a viable solution. Retries cause additional delays because the same error will be returned every time. Exponential backoff is a common retry strategy that employs increasing delays between retries, typically doubling in duration for each retry, causing a long total delay. Eventually, a retrying system shall give up. For batch requests, neighboring records will be lost.

Consequences arising from the above described problem under existing solutions include, without limitation: data being dropped due to unexplained errors; slowdowns as the same operations are retried over a period of time, often including exponentially increasing delays; pointless retries because the source system's behavior for toxic records may be deterministic; incomplete data gathering operation; and falling behind because the system cannot keep up-to-date data gathering.

Accordingly, a method and system that addresses the above-mentioned challenges is desired.

### SUMMARY OF THE INVENTION

In an embodiment of the invention, a computer-implemented method for handling toxic records within a data range request from a remote server comprises: (a) sensing the remote server for operation; (b) dividing, if the remote server is operational, the requested data range into a current data range and a deferred data range; (c) iteratively or recursively interrogating the current data range to identify toxic records and save valid records; (d) updating the current data range to the deferred data range from step (b); and (e) repeating steps (b) through (d), and optionally step (a), until there are no deferred data ranges available to request.

In an embodiment of the invention, the step of sensing the remote server comprises sending a no-op command to the remote server.

In an embodiment of the invention, the method comprises re-requesting the data range if the remote server is non-operational after a delay.

In an embodiment of the invention, the delay is input manually by a user input device.

In an embodiment of the invention, the method further comprises defining the data range requested by range-identifying information.

In an embodiment of the invention, the range-identifying information is based on input from a user input device.

In an embodiment of the invention, the method further comprises defining toxic records by number of records or data size.

In an embodiment of the invention, the defining is based on input from a user input device.

In an embodiment of the invention, the recursively interrogating step comprises: subdividing the current data range into a current data sub-range and a deferred data sub-range; requesting the records from the current data sub-range; saving records that are successfully requested; recording range-identifying information for any toxic records; updating the current data sub-range to the deferred data sub-range; and repeating the subdividing, requesting, saving, recording, and updating steps on the current data sub-range until no further deferred data sub- ranges are available to request.

In an embodiment of the invention, the method further comprises separately saving each deferred sub-range as it is created.

In an embodiment of the invention, the method further comprises continuously merging the deferred data range and the deferred data sub-range into one integrated deferred range.

In an embodiment of the invention, the data range request is performed periodically.

In an embodiment of the invention, the data range is based on a historical date, and includes the records from the historical date to the present or near present. In some embodiments, the data range is based on range identifiers and cursors.

In another embodiment of the invention, a system is programmed and operable to gather data from a remote server including data comprising at least one toxic record.

In embodiments of the invention, the system is programmed and operable to determine whether the data request error is transient, or results from a toxic record. If the error results from a toxic record, the system minimizes data loss by retrieving as much neighboring data as possible, even if the neighboring data is part of the same page or batch as the toxic record, and even if there are many toxic records on the same page or batch.

In embodiments of the invention, the system is programmed and operable to execute an iterative, and in some embodiments, a recursive interrogation module to repeatedly split and request the data ranges that contain a toxic record, and to record the toxic record location to a log error storage, and to save valid records to a database for analysis and computing metrics.

In preferred implementations, the method resumes after interruptions approximately where it left off. To do this, in implementations, the method regularly writes sub-ranges to non-volatile storage and iterates over the deferred sub-ranges.

In embodiments of the invention, the system further comprises a sync module, and wherein the sync module is programmed and operable to adjust the requested data range based on an operator or user's input.

In embodiments of the invention, the backend server is further programmed and operable to detect whether the remote server is operational based on sending a probe to the remote server.

In another embodiment of the invention, a computer-implemented method for automatically gathering data from a remote server including at least one toxic record comprises the steps of: requesting, by a backend server, an initial data range of records during a first phase; saving, to a data storage, all the records of the initial data range if all the records of the initial data range were successfully requested during the first phase; and cutting, by the backend server, the initial data range of records from the first phase into a plurality of tierᵢ₌₁ data sub-ranges if an error was received in response to the requesting step during the first phase.

In embodiments of the invention, the method further comprises: requesting in sequence, by the backend server, each of the plurality of tierᵢ₌₁ data sub-ranges during a second phase; evaluating whether the tierᵢ₌₁ data sub-range is successfully requested based on whether an error is received in response to the requesting, wherein if the tierᵢ₌₁ data sub-range receives an error during the requesting, record the failed tierᵢ₌₁ data sub-range; and if the tierᵢ₌₁ data sub-range does not receive an error, save to the data storage all the records of the tierᵢ₌₁ data sub-range; and continue the requesting and evaluating on the next available tierᵢ₌₁ data sub-range until each of the plurality of tierᵢ₌₁ data sub-ranges has been evaluated.

In embodiments of the invention, the method further comprises cutting, into a plurality of tierᵢ₌₂ data sub-ranges, each of the plurality of tierᵢ₌₁ data sub-ranges that received an error in response to the requesting step during the second phase.

In embodiments of the invention, the method further comprises: sequentially requesting each of the tierᵢ₌₂ data sub-ranges during a third phase; if requesting one of the tierᵢ₌₂ data sub-ranges fails during the third phase, record the failed tierᵢ₌₂ data sub-range; and if the tierᵢ₌₂ data sub-range does not receive an error, save to the data storage all the records of the tierᵢ₌₂ data sub-range; and continue requesting and evaluating on the next available tierᵢ₌₂ data sub-range until each of the plurality of tierᵢ₌₂ data sub-ranges has been evaluated.

In embodiments of the invention, the method further comprises repeating sequentially the steps of cutting, requesting, recording, and saving until a tierᵢ₌ₙ data sub-range reaches a threshold value.

In embodiments of the invention, the threshold value is based on a threshold size, number of records or time period.

In embodiments of the invention, the cutting is performed by splitting or dividing the subject data range into two equal or near-equal parts.

In embodiments of the invention, the initial data range has a range identifier selected from the group consisting of dates, record numbers, pages, time intervals, primary and other keys, and cursors.

In embodiments of the invention, the initial range identifier is input manually by an operator or user via an input device of a sync module.

In embodiments of the invention, the threshold value is input manually by a user via an input device.

In embodiments of the invention, the method further comprises re-requesting the recorded failed tierᵢ₌ₙ data sub-range(s).

In embodiments of the invention, the re-requesting is performed automatically after a time delay.

In embodiments of the invention, the re-requesting is triggered by an input from a user input device.

In embodiments of the invention, the method further comprises continuously coalescing any recorded failed tier_{i=1, 2, . . . n} data sub-ranges into one integrated/merged failed data range.

In embodiments of the invention, the method further comprises detecting whether the remote server is down prior to the cutting step, and rescheduling the first phase requesting step after a delay if the remote server is down.

In embodiments of the invention, the detecting is performed by sending a probe-type command to the remote server.

In embodiments of the invention, a processor is programmed for handling toxic records during data writing to a remote destination API. The data retrieval, range splitting, and sub-ranges can be applied to the data source system as described herein, while the error response, detection, and probes are applied to the destination API. In embodiments of the invention, the system and methods are programmed and operable to handle any API error during the retrieving or saving records, whether returned by a source or a destination API.

In embodiments of the invention, a toxic record implementation as described herein is integrated with a chunk data processing system, thereby improving the handling of toxic records within historical, long-range data syncs.

In embodiments of the invention, a computer-implemented method for automatically gathering data from a remote system comprises (a) requesting, by a server, a range of data from a remote system; (b) saving all the data within the range to a database system if all the data of the range was successfully requested; (c) dividing, by the server, the requested data range into data range portions if an error was received in response to the requesting; (d) requesting, by the server, each of the data range portions; and (e) saving each of the data range portions to the database system that was successfully requested.

In embodiments of the invention, the method further comprises: (f) subdividing, by the server, each data range portion if an error was received in response to the requesting of step (d).

In embodiments of the invention, the method further comprises: (g) continuously repeating steps (d) through (f) until (i) a minimum threshold data range is reached, or (ii) no more data range portions of data are available to request.

In embodiments of the invention, the threshold data range is one (1) data record or one (1) second.

In embodiments of the invention, each of the dividing steps comprises splitting into two parts.

In embodiments of the invention, the range of data comprises at least 1000 pages.

In embodiments of the invention, the method further comprises: subsequent to step (a), detecting by the server if the remote system is down, and rescheduling step (a) to be performed after a delay if the remote server is down.

In embodiments of the invention, the delay is at least 1 second.

In embodiments of the invention, the method further comprises: adjusting the range of data by date, time, or record number.

In embodiments of the invention, the adjusting is performed manually by a user through an input device.

An object and advantage of embodiments of the invention is to prevent failure and to cause as much of the data to be gathered as possible. Accuracy is improved in embodiments of the invention over computerized traditional retries and operator-assisted retries because data ranges are constructed to skip the smallest possible data range in order to avoid error responses. Additionally, computing speed is improved in embodiments of the invention because redundant retries are avoided.

Other aspects and advantages of the present subject matter will become apparent from the following detailed description taken in conjunction with the accompanying drawings, which illustrate, by way of example, the principles of the present subject matter.

### DESCRIPTION OF DRAWINGS

The present subject matter is illustrated by way of example, and not by way of limitation, in the figures of the accompanying drawings in which:

FIG. 1 shows a high-level schematic diagram of a toxic record handling system, according to one or more embodiments of the present invention;

FIG. 2 is a flow chart of an overview of a computer implemented method for handling toxic records, according to one or more embodiments of the present invention;

FIG. 3 shows another schematic diagram of a toxic record handling system, according to one or more embodiments of the present invention;

FIG. 4 is another flow chart of a computer implemented method for handling toxic records, according to one or more embodiments of the present invention;

FIG. 5 is an illustration of a data request from the backend server to a remote server, according to one or more embodiments of the present invention;

FIG. 6 is an illustration of a probe request from the backend server to a remote server, according to one or more embodiments of the present invention;

FIG. 7 is a flow chart of a computer-implemented method for recursively interrogating a data range, according to one or more embodiments of the present invention;

FIG. 8 is an illustration of remote-server data to be gathered, according to one or more embodiments of the present invention;

FIGS. 9A-9F depict a sequentially recursively interrogating a data range, according to embodiments of the invention; and

FIG. 10 is a block diagram of a computing system operable to implement techniques described herein, according to one or more embodiments of the present invention.

### DETAILED DESCRIPTION

Before the present invention is described in greater detail, it is to be understood that this invention is not limited to particular embodiments described, and as such can, of course, vary. It is also to be understood that the terminology used herein is for the purpose of describing particular embodiments only, and is not intended to be limiting, since the scope of the present invention will be limited only by the appended claims. Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges can independently be included in the smaller ranges and are also encompassed within the invention, subject to any specifically excluded limit in the stated range. Where the stated range includes one or both of the limits, ranges excluding either or both of those included limits are also included in the invention. Although any methods and materials similar or equivalent to those described herein can also be used in the practice or testing of the present invention, representative illustrative methods and materials are now described. It is noted that, as used herein and in the appended claims, the singular forms “a”, “an”, and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation. As will be apparent to those of skill in the art upon reading this disclosure, each of the individual embodiments described and illustrated herein has discrete components and features which can be readily separated from or combined with the features of any of the other several embodiments without departing from the scope or spirit of the present invention. Any recited method can be carried out in the order of events recited or in any other order that is logically possible.

All existing subject matter mentioned herein (e.g., publications, patents, patent applications and hardware) is incorporated by reference herein in its entirety except insofar as the subject matter may conflict with that of the present invention (in which case what is present herein shall prevail).

Unless otherwise defined, all technical and scientific terms used herein have the same meaning as commonly understood by one of ordinary skill in the art. In case of conflict, the present document, including definitions, will control.

### Definitions

Batch: a batch of data typically refers to a group of records that are processed together as a single unit or part of the same operation.

Data: data is the information that can be stored in a record.

Page: an example of a page is a limited number of records that is used as a unit of transfer between different devices.

Sync: as used in some embodiments described herein, is the process of synchronizing a range of data through a series of requests that iterate between different devices or data stores. Syncs can be inbound, outbound, or bidirectional. Syncs can also be tuned or identified by different range-identifying information.

Record: a record is a collection of fields that contain data about an entity. A record is often represented as a row in a table, and each column in the table can hold a specific data type.

Toxic Record: a record in the remote system that, in combination with software or configuration on the remote system, causes requests to retrieve or process it to fail. The entire request may fail even if there are other records in the same batch that would have otherwise succeeded.

Described herein are various methods and systems for effectively gathering a range of data despite the data comprising a toxic record. As described herein, in embodiments, if the error results from a toxic record, the system minimizes data loss by retrieving as much neighboring data as possible, even if the neighboring data is part of the same page or batch as the toxic record, and even if there are many toxic records on the same page or batch.

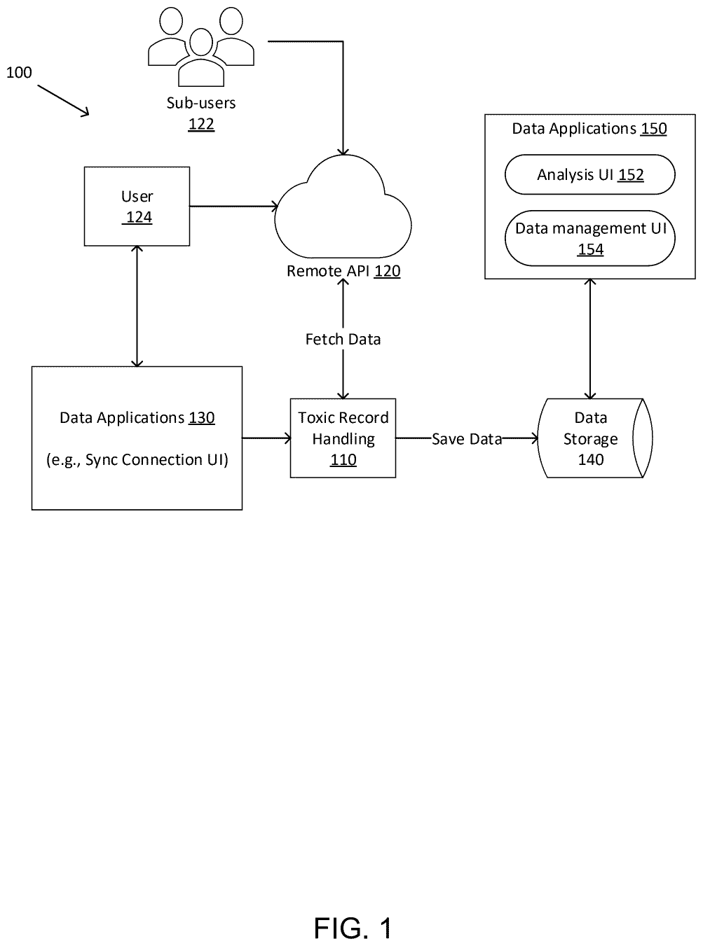

FIG. 1 is a high-level overview of a data range gathering system 100, according to one or more embodiments of the present invention. The system includes a toxic record handling module 110 operable to fetch data from at least one remote server 120 or remote API. An example of a remote API is, without limitation, an API for connecting with a service platform such as, without limitation, Magento 2 and Prestashop. In a non-limiting example, a sub-user (e.g., customer) 122 connects with the remote server website 120 (e.g., Shopify) to purchase goods and services from the user 124 (e.g., a business selling the goods and services). A wide variety of types of sub-user behaviors and actions are detected and stored to the remote API including, without limitation, biographical and geographical information, purchase events, amount spent, number of purchases, electronic message open rates, etc., all of which information and data can be stored by the remote server.

With reference again to FIG. 1, the range of data to be fetched (or sync configuration) by the toxic record handling module 110 is identified according to a user connector application 130 which can include a user interface (UI). In an exemplary embodiment, the connector application 130 is programmed and operable to allow the user 124 to input sync parameters or range-identifying information to tune the sync, described further herein.

Records successfully fetched can be saved to a data storage 140, such as, for example, an online application processing (OLAP) or online transaction processing (OLTP) database. In the system 100 shown in FIG. 1, various data applications 150 including an analytics module 152 and a data management module 154 are provided to analyze and manage the data in the data storage 140, as described further herein.

Toxic records are logged to an error log and can be re-evaluated later, as described further herein.

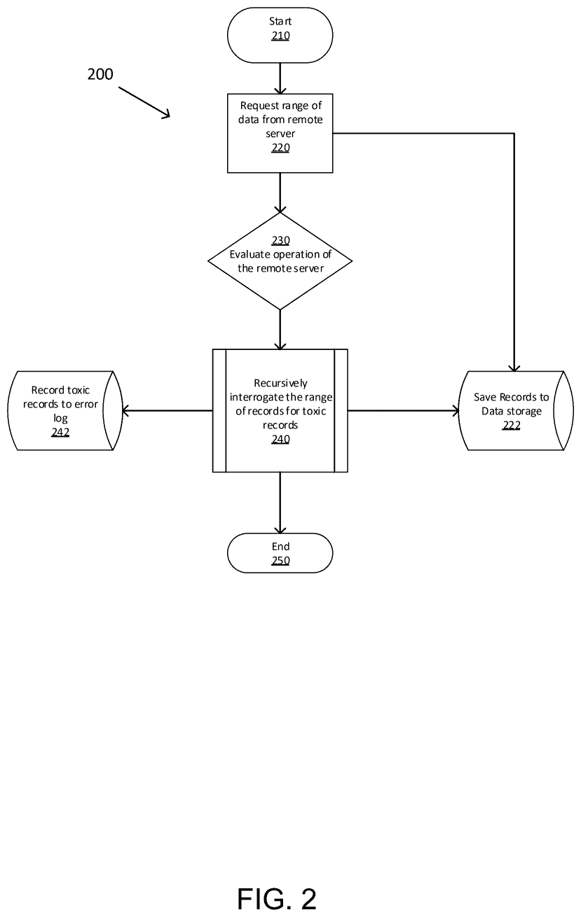

FIG. 2 is a flowchart of a method for toxic record handling 200 in accordance with an embodiment of the invention.
Step 210 states to begin the method.
Step 220 states to request a range of data from the remote server. This step may be performed by a toxic record handling module implemented on a computer, server, or server framework, sometimes referred to herein as the backend server. If all the data is successfully requested, method proceeds to step 222 and stores the records to data storage (e.g., data storage 140 shown in FIG. 1).
Step 230 states to evaluate operation of the remote server. This step is performed if an error arises in response to the initial fetch request 220. Step 230 detects whether the remote server (or the server module involved with this data retrieval task) is non-functional or non-operational. In embodiments, the backend server probes the remote server for non-operation by sending a ‘no-op’ or ‘get’ command to the remote server.
Step 240 states to recursively interrogate the range of records for toxic records. In embodiments, a recursive interrogation of the data range is performed if the remote server is operational until the entire range is evaluated for toxic and valid records.
Step 242 records or stores the location of the toxic records. In embodiments, the toxic records are re-evaluated, described further herein.
Step 222 saves the valid records to a database for analysis (e.g., data storage 140 shown in FIG. 1).
Step 250 states end of the method.

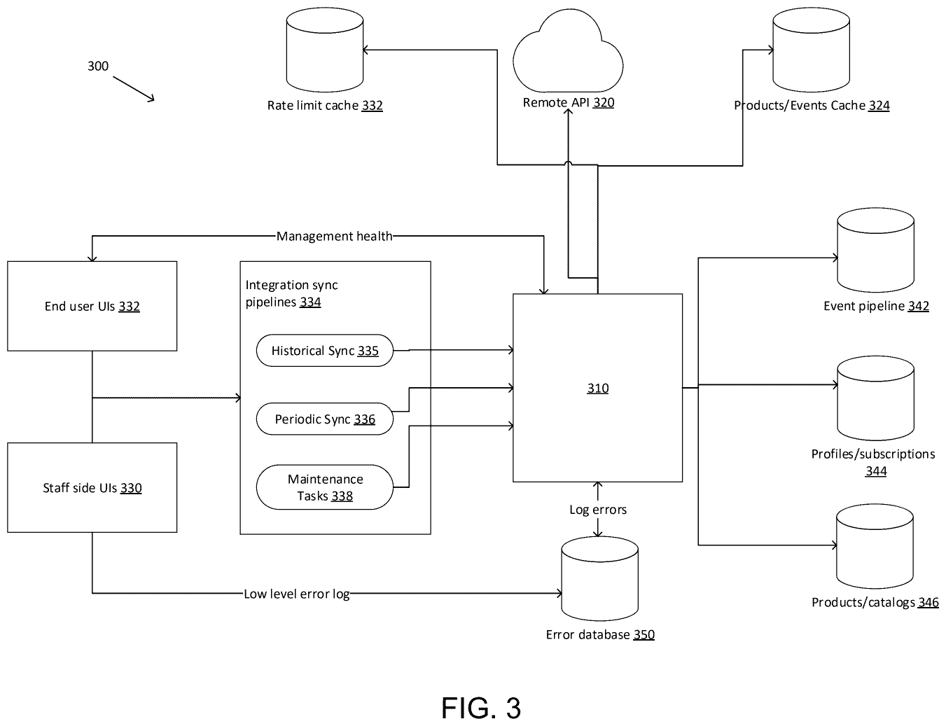

FIG. 3 is another more detailed schematic diagram of a toxic record handling system 300 in accordance with embodiments of the invention.

The toxic record handling system 300 is shown including several systems that directly connect to the toxic record handling backend server 310.

### User Interfaces

User interfaces (UI) 330, 332 are provided to connect with the backend server 310. In embodiments, a staff-side user interface 330 and client-side user interface 332 allows the user to create and monitor syncs. Staff-side users also have access to low-level error logs 350 that were generated during sync execution, described further herein. A UI may be implemented on, e.g., a computer, laptop, or mobile device such as a tablet or smartphone.

### Sync Pipelines

In the embodiment shown in FIG. 3, there is a sync application configuration 334 including three sync pipelines that the backend server 310 handles including: historical syncs 335, periodic syncs 336, and maintenance tasks 338. In embodiments, historical syncs are run once and gather past data for several years (e.g., the historical sync may commence at a past or historical timestamp/date through present or near present time). Periodic syncs are run perpetually and gather updated data at a regular interval (e.g., every hour). Maintenance and repair-type syncs can be run manually (e.g., triggered by a user on a user interface device) over a subset of the full historical sync range (e.g., an interval between two dates or record numbers).

FIG. 3 also shows remote API 320. As described above, an example of a remote API is the Magento 2 API, arranged on a remote cloud-based server. However, the invention is not intended to be so limited and the backend toxic record handling server 310 can operate with a wide range of different types of remote APIs 320 to fetch data therefrom.

### Caches

FIG. 3 also shows several caches including a rate-limit cache 322 and products/events cache 324 collectively serving to (a) avoid remote system overload; (b) avoid overhead in time and network bandwidth of sending (further) requests that will be rejected by the remote server due to its load; and (c) allowing other higher-priority tasks to contact the server without being rejected due to rate-limits themselves.

In embodiments, the rate-limit cache 322 is used to cache rate-limit headers in order to optimize rate-limit quota usage across processes. Without intending to be bound to theory, rate limiting is a technique that limits the number of requests sent to a server or an API endpoint in a specified time frame, and serves to prevent overloading the system, ensuring that it remains responsive and reliable, and improves performance. Each request is checked by the rate limiter, which looks up the user's IP address or other identifiers in the cache or database to determine if they have exceeded their rate limit. If the user has exceeded their rate limit, the rate limiter rejects the request with, e.g., a “429 Too Many Requests” response. If the user has not exceeded their rate limit, the request is forwarded to the application's business logic, which processes the request and returns a response.

In embodiments, the products/events cache 324 is used to reduce call volume to remote APIs and external networked services.

FIG. 3 also shows an error/issue handling framework including an error database 350 in which the toxic record handling module 310 writes errors thereto. Optionally, the write error logs stored on the error database 350 can be displayed or available to users via the user interfaces 330, 332 described above.

A wide range of external downstream systems can be included in the toxic records handling system 300 for saving data including, for example, the event pipeline database 342, profiles/subscriptions database 344, or products/catalog database 346, each of which may be accessed by a user interface (UI).

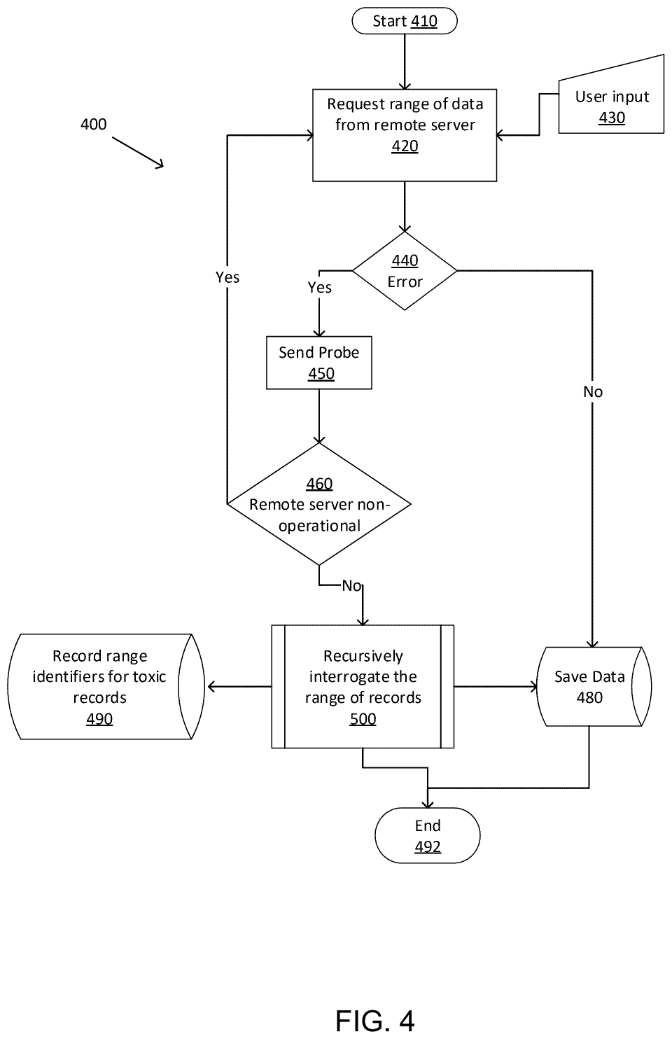

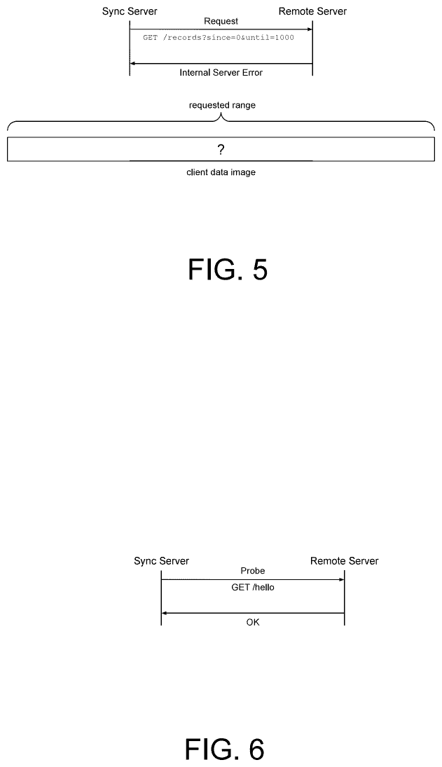

FIG. 4 is another flowchart of a method for toxic record handling 400 in accordance with an embodiment of the invention.
Step 410 states to begin the method.
Step 420 states to request an initial range of data from the remote server. This step may be performed by a toxic record handling module or sync server described above by sending a data request to the remote server. An illustration of a data request is shown in FIG. 5 in the form of a ‘GET/records’ command for all the records from one (1) and until one thousand (1000).
Step 430 states user input. As described above with reference to FIG. 3 above, the user may set sync parameters for fetching the data including historic, periodic, and maintenance type requests. Optionally, the user may set the time or delay between periodic data requests, the historical date range, or a time or record interval. In some embodiments, the schedule for syncing data records is automatically set up based on the user registration process with the host or backend server. For example, when a user registers, the backend toxic record handling system sets a default periodic or historic sync schedule for the user until otherwise modified.
Step 440 queries for whether an error is received in response to the data request. If all the data is successfully requested, method proceeds to step 480 and stores the records to data storage (e.g., data storage 140 shown in FIG. 1).

However, and with reference to Step 450, if an error arises in response to the request, a probe is sent to the remote server. Step 450 detects (or senses) whether the remote server is non-functional or non-operational. In embodiments, and with reference to FIG. 6, the sync or backend server probes the remote server for non-operation by sending a ‘no-op’ or ‘GET’ command to the remote server. A no-op or NOOP command is a command that a client can issue to request a response from the server without requesting any other actions. Such a command can be used to ensure the connection is still alive or that the server is responsive. Examples of protocols that have NOOP commands include, without limitation: telnet, FTP, SMTP, X11, and POP3.

There are many different types of errors that can occur when requesting data from the remote server. Examples of classes of errors in the context of toxic record handling include, without limitation: ambiguous errors and non-ambiguous errors. In embodiments, the HTTP status code and message included in the error body are used to evaluate to which class a particular error belongs. For example, if an HTTP 404 error is received, the error can be classified with high certainty that this error was not caused by a toxic record. However, if an HTTP 500 error is received, the error can be classified as toxic record-related, and the process should initiate the toxic record handling code-path as described herein. Although the error classification has been described above based on HTTP, the invention is not intended to be so limited. In other embodiments, protocols other than HTTP can be implemented to determine the class of error. The invention is only intended to be limited as recited in any appended claims.
Step 460 queries for whether the remote server is down.

If the remote server is down, the method can return to step 420 and repeat the initial data request or modify the request. In embodiments, the request is repeated after a delay. The delay may range from 1 second to 1 hour or more preferably 1 second or less. Optionally, the re-request may be performed manually upon a user prompt. Optionally, the re-request is performed periodically, e.g., hourly. Optionally, the delay is increased exponentially until a maximum value is reached at which point the requesting step is halted.

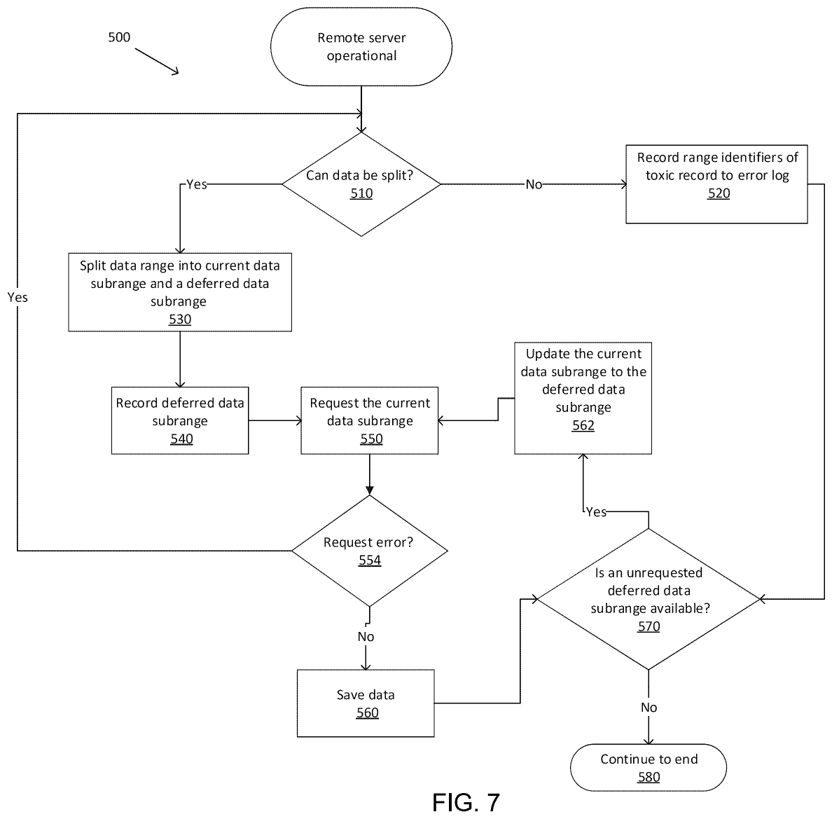

If the remote server is not down, the method proceeds to step 500.
Step 500 states to recursively interrogate the range of records for toxic records. In embodiments, an iterative (optionally, recursive) interrogation of the data range is performed if the remote server is operational until the entire range is evaluated for toxic and valid records. As described further herein in connection with FIG. 7, data loss is minimized by retrieving as much neighboring data as possible, even if the neighboring data is part of the same page or batch as the toxic record, and even if there are many toxic records on the same page or batch. This step is repeated until all available deferred data have been evaluated.
Step 490 records or stores the location of the toxic records. In embodiments, the toxic records are re-evaluated. Optionally the toxic records are re-evaluated automatically after a delay. In other embodiments, or in addition to, a user may trigger the re-evaluation of the toxic records.
Step 480 saves the valid records to the database for analysis, described herein.
Step 492 states end of the method.

### Iterative or Recursive Interrogation

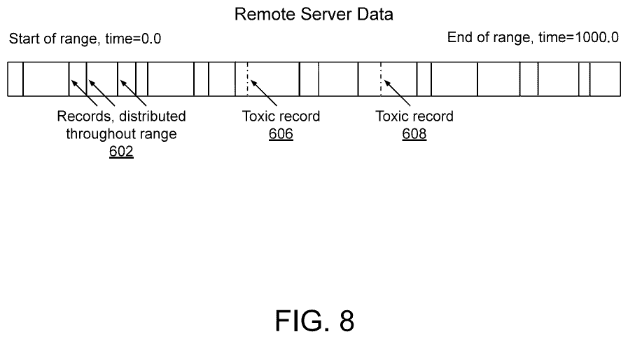

FIG. 7 is a detailed flowchart for step 500 to iteratively or recursively interrogate the initially requested data range (e.g., records 1 to 1000 illustrated in FIG. 8), according to embodiments of the invention. The initial data range can comprise a plurality of records distributed throughout the range including valid records 602 and toxic records 606, 608. The locations of the toxic records are not known. In the embodiment shown in FIG. 7, the process 500 commences if the remote server is operational.
Step 510 queries whether the data range can be split. This step can be performed by the backend server framework (e.g., backend servers 110, 310 described above). In preferred embodiments, the instant data range is evaluated for whether it can be split in half. In embodiments, if the instant range is equal to or greater than a minimum size, it is split. In embodiments the minimum size depends on the remote API and whether there is a gap between the upper and lower pointers of the data range. For example, in embodiments, the minimum size is one (1) page, record or second.

If the data range cannot be split, the method proceeds to step 520. Step 520 records the range identifiers of the toxic record(s) to an error log. For example, the backend server may send the range identifiers of the toxic records to an error log database (e.g., error database 350, described above), where the information may be accessed by users via a user interface (e.g., UI 330, described above).

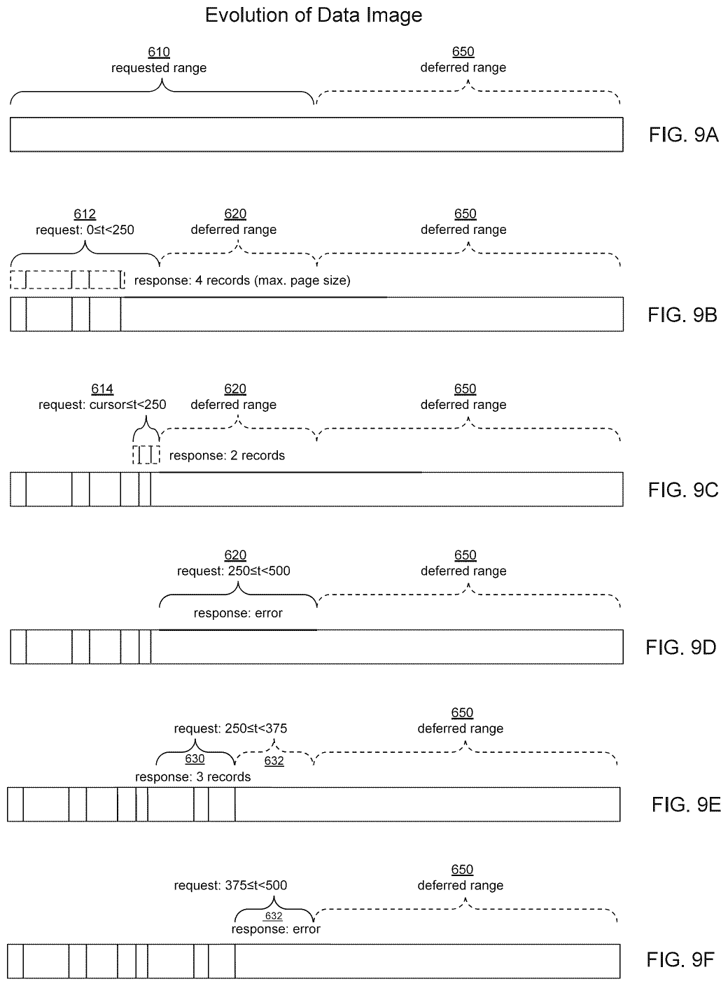

If the data range is large enough to be split, the method proceeds to step 530. With reference to the illustration shown in FIG. 9A, the data range is split into a current requested data range 610 and an adjacent deferred data range 650, either of which may contain the toxic record(s). This step can also be performed by the backend server and preferably splits the data range into two pieces of equal size or pages. However, in other embodiments, the data range is broken up into more than 2 data ranges.
Step 540 states to record the deferred data range (e.g., deferred data range 650 described above). The deferred data range is recorded and can be evaluated later, typically immediately after the current range is requested, described herein.
Step 550 states to request the current data sub-range. This step may be performed by the toxic record handling module or server 110, 310 described above by sending a data request to the remote server for the current data sub-range 610.
Step 554 queries for whether an error is received in response to the data request of step 550. If all the data is successfully requested (i.e., no error), the method proceeds to step 560 and stores the valid records to data storage (e.g., data storages 140, 342, 344, or 346, described above.

However, if an error arises in response to the step 550 request, and with reference to FIGS. 9B-9F, the method sequentially repeats steps 510, 530, 540, 550, and 554, cutting the requested data range into smaller and smaller sub-ranges (e.g., requested sub-range 612, 630) and deferred sub-ranges (e.g., 620, 632) until the requested range can no longer be divided in which case the data range is recorded to the error log.

If an error does not arise in response to the step 550 request, the method proceeds to step 560 and the valid records are saved to the databases described herein.
Step 570 states to query whether an unrequested deferred data range (e.g., 650) or sub-range (e.g., 620, 632) is available. This step proceeds after (a) the toxic records have been recorded (namely, step 520) or (b) a valid record or page is saved (namely, step 560). In either event, the method proceeds to evaluate the next available deferred data range (e.g., 620, 632, 650, etc.).

If another deferred sub-range or deferred range is available to request, the method moves to step 562 and updates (namely, replaces) the current range with the deferred range and returns to step 550.

If another deferred sub-range 536 or deferred range 544 is not available to request, the method is complete and ends as indicated in step 580.

FIGS. 9A-9F depict a sequential illustration of recursively interrogating a data range 600 for toxic records, according to embodiments of the invention.

FIG. 9A shows the initial data range 600 split into a requested range 610 and deferred range 650 during a phase i=1, as described above. It is not known whether the toxic records are in the requested range 610 or the deferred range 650.

FIG. 9B shows the data range 610 sub-divided into a requested sub-range 612 and a deferred sub-range 620 during a phase i=2. A 2^{nd} request is made for the entire data range 612 [0<t<250]. However, in this instance, the maximum page size (namely, 4 records) is reached prior to gathering the entire data range 612. Consequently, 4 records are fetched during the first request of phase i=2.

FIG. 9C shows a second request for the balance of the data range 612 to obtain the remaining 2 records during the i=2 phase. All records from data range 612 are shown to have been successfully gathered and can be stored as described above.

With reference to FIG. 9D, the method interrogates the next deferred data range, namely, data range 620 [250<t<500] in which an error is returned.

With reference to FIGS. 9E-9F, the offending range is further split into two sub-ranges 630, 632 during phase i=3. Particularly, the data range 620 is shown being split into a requested sub-range from 250<t<375 and a deferred sub-range 375<t<500 wherein 3 records are successfully gathered between 250<t<375 and a response error is returned over the range 375<t<500.

This recursive evaluation on the data range is repeated as described above for i=n phases until the offending data range can no longer be sub-divided in which case the offending data range is recorded to a log error database.

The method then continues to evaluate the next or adjacent deferred data range until no further deferred data ranges are available.

In embodiments, each time a deferred data range is defined, it is stored separately to memory. For example, it is stored to state memory.

In other embodiments, each time a deferred data range is defined, it is merged or coalesced with the existing deferred data range resulting in only one deferred data range during the method. Continuously merging the deferred data ranges into one integrated deferred data range has the advantage of saving computing resources over separately storing each deferred data range.

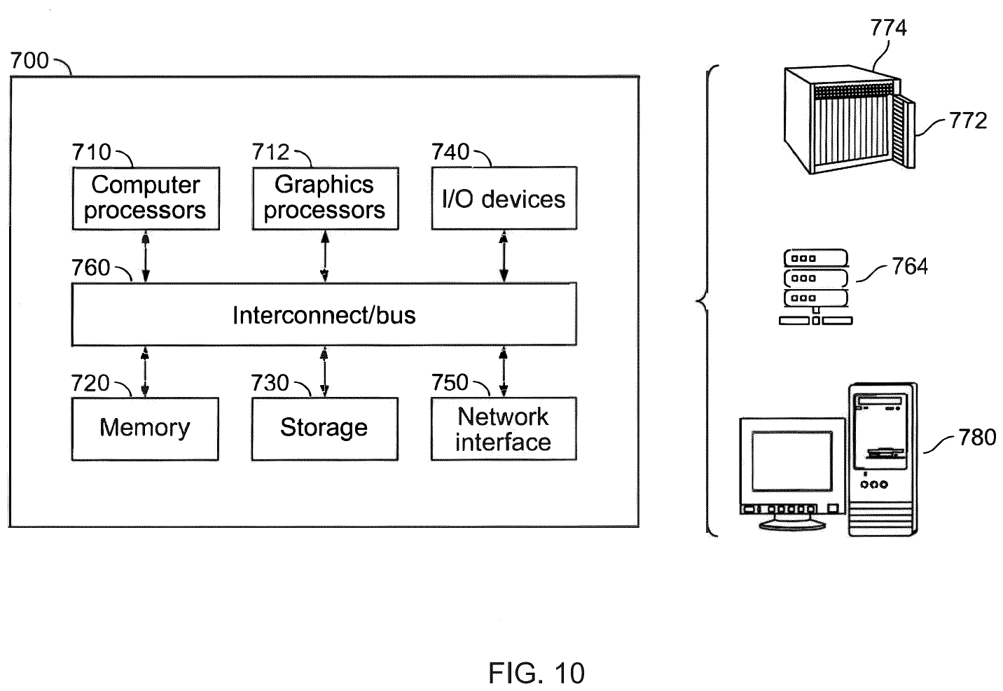

FIG. 10 is a block diagram of a computing system 700 used to implement the techniques/processes described herein in accordance with embodiments of the invention. The computing device 700 is intended to represent various forms of digital computers, such as servers 764, 774, workstations, desktops 780, laptops, and other types of computing devices. The components shown here, their connections and relationships, and their functions, are meant to be exemplary only, and are not meant to limit implementations of the inventions described and/or claimed herein.

The computing device 700 is shown including: a computer processor 710, graphic processor 712, memory 720, storage 730, input output devices 740 and network interface 750.

The processors 710, 712, memory 720, storage 730, and network interface 750 are interconnected using various interconnect busses 760, and may be mounted on a common motherboard or in other manners as appropriate. The processor(s) can process instructions for execution within the computing device 700 to carry out the operations described herein, and including instructions stored in the memory 720 to display graphical information for a GUI on a display unit coupled to the network interface, I/O ports, or dedicated video card (not shown).

The memory 720 stores information within the computing device 700. In some implementations, the memory 720 is a volatile memory unit or units. In some implementations, the memory 720 is a non-volatile memory unit or units. The memory 720 may also be another form of computer-readable medium, such as a magnetic or optical disk.

The storage device 730 can provide mass storage for the computing device 700. In some implementations, the storage device 730 may be or contain a computer-readable medium, such as a hard disk device, an optical disk device, a tape device, a flash memory or other similar solid state memory device, or an array of devices, including devices in a storage area network or other configurations.

In some implementations, a computer program product may also contain instructions that, when executed, perform one or more methods, such as those described above. The computer program product can also be tangibly embodied in a computer-or machine-readable medium or media, such as the memory 720 or the storage device 730.

The input/output devices 740 are connected to the system via an input/output interface. Examples of input/output devices include, without limitation, sensors such as touch screen sensors, geolocation receivers, microphones, speakers, keyboard, mouse, printer, Bluetooth peripherals, and USB devices to communicate with the internal components of the computing device. In some embodiments, a user behavior or selection may be obtained or sensed by the input output devices, and used to form segments and audiences, determine data range-identifying information, and select metrics as described herein. Examples of user inputs are, without limitation: update ranges (dates, IDs, etc.); mark ranges with identified toxic records as failed (system won't retry); mark ranges with identified toxic records as retriable (system will perform limited retry); and mark failed ranges as retriable (these ranges either failed before or were marked as failed by users). Users can also start, pause, or cancel syncs, or restart them with a modified range.

Network interface 750 can include various communication ports (e.g., USB, Bluetooth, Ethernet, wireless Ethernet). The network interface 750 can allow the processors to access the Internet through wired or wireless connections such as WIFI, 3G, 4G long-term evolution (LTE), 5G, and other wireless interface standard radios as well as Ethernet connection hardware. In embodiments, portable or mobile computing devices such as tablets and smart phones and PDA devices are programmed and operable to connect to the backend, host, or remote servers for carrying out some of the above described steps. For example, an APP may be downloaded to a tablet or smartphone and include a GUI for accepting data range-identifying information, data sync configurations, or threshold values for determining the minimum size for a toxic record to be recorded.

The computing device 700 may be implemented in a wide variety of different forms. For example, it may be implemented as a standard server 764 or a desktop computer 780.

In some embodiments, multiple processors and/or multiple buses are combined, as appropriate, along with multiple memories and types of memory. Multiple computing devices may be connected, with each device providing portions of the necessary operations (e.g., as a server bank, a group of blade servers, or a multi-processor system). Examples of server systems for implementing the processes and methods described herein include, without limitation, cloud data centers with rack-mounted servers 764, blade server systems 774, etc.

In embodiments, different servers (optionally at different locations) carry out different steps or processes of the invention. For example, a sync server may be programmed and operable to interface with the user and to set or adjust the range of data to be fetched, a toxic record handling server may be programmed and operable to recursively interrogate the data for toxic and valid records, an error log server may be programmed and operable to manage and store the toxic record locations, and a database management server may be programmed and operable to manage the database for analytics and metrics. In a preferred embodiment, the server may be configured as a server framework, cluster, or distributed computing system of servers or nodes to perform the steps, and serving to distribute workloads consisting of a high number of individualized, parallelizable tasks among the nodes in the cluster. A non-limiting example of a suitable distributed computing system is AWS by Amazon Web Services, Inc. (Seattle, WA). Indeed, the components shown here, their connections and relationships, and their functions, are meant to be exemplary only, and are not meant to limit implementations of the inventions described and/or claimed herein.

### Alternative Embodiments

It is to be understood the above described methods and systems for handling records may vary widely.

For example, although the above disclosure describes handling toxic records during data retrieval, embodiments of the invention could equally handle toxic records during data writing (e.g., where a remote API system has to update an existing record, and to do so the remote API must process the existing data internally, and the record turns out to be toxic). In embodiments, a processor can be programmed to catch and account for this type of error, irrespective of whether the operation was a read or a write. In embodiments, the data retrieval, range splitting, and sub-ranges can be applied to the data source system, while the error response, detection, and probes apply to the destination API. In embodiments of the invention, systems and methods are operable to handle any API error arising during the course of retrieving or saving records, whether returned by a source or a destination API, by, optional probes of the system that returned the error, and splitting the ranges of the source data request as described herein.

In embodiments, the system or method applies a data chunking process in the application of the sync rules or logic. Chunking can be used for long-range syncs (e.g., multi-year data backfills) as a workaround for APIs that lack support for fetching data in the desired order. This chunking technique enables the system and its users to track the overall syncing progress and sync the most recent data first, thereby maximizing its business value. For example, in embodiments, each set of distinct sync parameters are represented by its own HistoricalSyncTask record, containing parameters that identify the sync, columns for scheduling, status, and progress reporting, and a “range” column for the current range, with an associated list of “chunks”, with each chunk representing a pending range. The chunks split the original full range into ordered parts, for purposes that may include presenting more accurate progress information to the user, syncing data in a priority order that differs from the available iteration orders (such as retrieving chunks from newest to oldest to maximize relevance to the user, when the remote API only supports iterating forwards in time), or conforming to other segmentation needs of a local or remote API. A single task record will represent both historical sync chunking tasks as well as historical sync execution tasks, with the is_chunking flag being used to determine whether or not the chunking process is finished. If is_chunking is true, the executor will start (or resume) the historical sync's chunking process. As it progresses, chunks will be written to the chunks list, and the range column will be used for progress saving purposes so that long-running chunking tasks do not need to start over if interrupted. Once the chunking subtask is finished, the executor will set is_chunking to False and tee up a chunk for syncing by following the advance-to-next-chunk logic, which moves the next chunk in the list to the “range” column and updates progress information. The same logic is used during syncing when the current range is exhausted. The same chunks list can also be used to store the deferred sub-ranges for toxic record handling.

When retrieving data by a chunking process, certain ranges within a chunk may fail due to the presence of a single toxic record. In embodiments of the invention, the implementations to handle toxic records as described herein are integrated with the chunk processing system, enabling the handling of any number of toxic records within long-range data syncs.

Throughout the foregoing description, and for the purposes of explanation, numerous specific details are set forth in order to provide a thorough understanding of the described techniques. It will be apparent, however, to one skilled in the art that these techniques can be practiced without some of these specific details. Although various embodiments that incorporate these teachings have been shown and described in detail, those skilled in the art could readily devise many other varied embodiments or mechanisms to incorporate these techniques. Also, embodiments can include various operations as set forth above, fewer operations, or more operations; or operations in another order than that specifically described above. Additionally, any of the components and steps described herein may be combined with one another in any logical manner except where such components or steps would be exclusive to one another. Accordingly, the scope and spirit of the invention should be judged in terms of the claims, which follow as well as the legal equivalents thereof.

What is claimed is:

1. A computer-implemented method for handling error responses from a remote server potentially arising from the presence of one or more toxic records within a data range requested, the method comprising:
(a) sensing the remote server for operation;
(b) dividing, if the remote server is operational, the requested data range into a current data range and a deferred data range, wherein the dividing is performed by a backend server programmed and operable to perform the dividing step;
(c) recursively or iteratively interrogating the current data range to identify toxic records and save valid records;
(d) updating the current data range to the deferred data range from step (b); and
(e) repeating steps (b) through (d), and optionally step (a), until there are no deferred data ranges available to request.

2. The method of claim 1, wherein the step of sensing the remote server comprises sending a no-op command from the backend server to the remote server, and re-requesting the data range if the remote server is non-operational after a delay.

3. The method of claim 1, further comprising defining the data range requested by range-identifying information and based on input from a user input device.

4. The method of claim 1, wherein identifying the toxic records is based on defining a minimum number of pages, records or data size that is not splittable, and based on input from a user input device.

5. The method of claim 1, wherein the recursively or iteratively interrogating step comprises:
subdividing the current data range into a current data sub-range and a deferred data sub-range;
requesting the records from the current data sub-range;
saving records that are successfully requested;
recording range-identifying information for any toxic records;
updating the current data sub-range to the deferred data sub-range; and
repeating the subdividing, requesting, saving, recording, and updating steps on the updated current data sub-range until no further deferred data sub-ranges are available to request.

6. The method of claim 5, further comprising separately saving each deferred sub-range as it is created.

7. The method of claim 6, further comprising continuously merging the deferred data range and the deferred data sub-range into one integrated deferred range.

8. The method of claim 7, wherein the data range is based on a historical date, and includes the records from the historical date to the near-present time.

9. The method of claim 1, comprising automatically performing the sensing step prior to each requesting step, and optionally, if an error is received, to classify the error based on information about the error received.

10. The method of claim 1, comprising defining the dividing step, and optionally, wherein the defining is performed by the user via an input device.

11. A data range gathering system for retrieving data from a remote system comprising:
a database system for storing gathered data;
a sync module, programmed and operable to allow a user to configure data requests by range-identifying information;
a backend server programmed and operable to:
request a data range of data from a remote system based on the range-identifying information;
save the data to the database system if the data range was successfully requested;
divide the data range into data range portions if an error occurs during data retrieval in response to the data request;
request each of the data range portions from the remote system;
save each data range portion to the database system that was successfully requested.

12. The system of claim 11, wherein the backend server is further programmed and operable to divide the data range portion into data range sub portions if an error was received in response to the request for the data range portion.

13. The system of claim 12, wherein the backend server is further programmed and operable to further request each of the data range sub portions from the remote system.

14. The system of claim 13, wherein the backend server is further programmed and operable to save each data range sub portion to the database system that was successfully requested.

15. The system of claim 14, further comprising an error log database, and wherein the backend server is further programmed and operable to record the location of each record unsuccessfully requested.

16. The system of claim 15, and wherein the backend server is further programmed and operable to repeat the dividing, requesting, saving and recording until the data range portion reaches a threshold value, or no more data ranges are available to evaluate.

17. The system of claim 16, further comprising a sync module, and wherein the sync module is further programmed and operable to set or adjust the threshold value.

18. The system of claim 17, wherein the backend server is further programmed and operable to detect whether the remote server is operational based on sending a probe to the remote server.

19. A computer-implemented method for automatically retrieving data comprising a plurality of records from a remote server, the method comprising:
(a) requesting, by a backend server, an initial data range of records during an initial phase;
(b) saving, to a data storage, all the records of the initial data range if all the records of the initial data range were successfully requested during the initial phase;
(c) probing the remote server for operation status if an error was received in response to the requesting step for whether the remote server is online;
(d) if the remote server is not online, then retry the requesting step;
(e) if the remote server is online:
(f) dividing the initial data range into a current range and a deferred range,
(g) requesting the records from the current range, and if the records from the current range are successfully requested, save the records; and
if a record from the current range is unsuccessfully requested, then
(h) subdividing the current range into an updated current range and updated deferred range until the records in the updated current range are successfully requested or the updated current range reaches a threshold;
wherein if the updated current range reaches the threshold, then
(i) recording to an error log the range identifiers for the updated current range that reaches the threshold; then
(j) querying whether a deferred data range is available for requesting, and if a deferred data range is available, updating the current range to the deferred data range and repeating the steps (g) through (j) until no more deferred ranges are available to request.

20. The method of claim 19, further comprising merging with each subdividing the deferred range with any updated deferred range, thereby maintaining only one integrated updated deferred range.
